(19) United States
(12) Patent Application Publication
(10) Pub. No.: US 2010/0051157 A1
(43) Pub. Date: Mar. 4, 2010

(54) INSERT AND BELT OVERLAY CONTAINING CHOPPED CARBON FIBERS

(76) Inventors: BINA PATEL BOTTS, CUYAHOGA FALLS, OH (US); AARON SCOTT PUHALA, KENT, OH (US); PAUL HARRY SANDSTROM, CUYAHOGA FALLS, OH (US); WALTER KEVIN WESTGATE, UNIONTOWN, OH (US); RACHEL REBEKAH BARNETTE, AKRON, OH (US)

Correspondence Address: Emerson, Thomson & Bennett, LLC, 777 W. Market Street, Akron, OH, 44303, US

(21) Appl. No.: 12/201,768

(22) Filed: Aug. 29, 2008

(51) Int. Cl. B60C 9/12

(52) U.S. Cl. 152/458

(57) ABSTRACT

A tire including a carcass, at least two bead regions having a pair of axially spaced beads around which are wrapped turn-up ends, reinforced carcass plies wrapped around the pair of beads, at least one belt structure and tread disposed over the carcass plies, sidewalls disposed between the beads and the tread, at least two apexes, wherein the apexes are a main body of the carcass and the turn-up ends, an EMT insert, and at least one belt overlay; wherein at least one of the group consisting of the apexes, the EMT insert, and the at least one belt overlay contain chopped carbon fibers.

### I. BACKGROUND OF THE INVENTION

A. Field of Invention

This invention pertains to the art of methods and apparatuses regarding tires, and more particularly to methods and apparatuses regarding chopped carbon fibers in inserts, apexes, and belt overlays.

B. Description of the Related Art

It is known in the art to provide carbon fibers in bead reinforcing plies.

U.S. Patent Appln. No. 2007/0221303 discloses tire having a circumferential rubber tread of a cap/base construction composed of a cap rubber layer as the tire running surface and an internal base rubber layer underlying said tread cap layer. The said tread cap layer is composed of a primary tread cap portion and one or two lateral tread cap portions of rubber compositions containing precipitated silica and/or rubber reinforcing carbon black reinforcement and wherein the rubber composition of at least one of said lateral tread cap portions contains a dispersion of short carbon fibers. Said primary tread cap portion contains a major portion of the running surface of the tread and is comprised of a silica-rich or carbon black-rich, preferably silica-rich, reinforcement-containing rubber composition, and said lateral tread portion(s) contains a minor portion of the running surface of the tread and is comprised of a silica-rich or carbon black-rich, preferably carbon black-rich, reinforcement-containing rubber composition. Where said primary tread cap portion is comprised of a silica-rich rubber composition, said lateral tread cap portion(s) is comprised of a carbon black-rich rubber composition and visa versa. The said tread cap portions are load bearing portions in the sense of extending from the running surface of the tread radially inward to said underlying tread base layer. In one aspect, the portioned rubber tread cap layer and the rubber tread base layer are co-extruded together to form a unitary composite thereof.

U.S. Patent Appln. No. 20070125469 discloses a pneumatic radial tire having a carcass and a tread. The carcass has at least one carcass reinforcing ply and opposing bead portions. Each bead portion has a bead core and a bead apex radially. The apexes in each bead portion having the same radial height (HA), as measured from a bead base line (B). The tire has a bead reinforcing ply comprising chopped carbon fiber in the amount of 0.5 to 30 parts per hundred rubber located in only one bead portion of the tire, with the bead reinforcing ply being adjacent to the carcass reinforcing ply.

U.S. Patent Appln. No. 20070125468 discloses a pneumatic radial tire having a carcass and a tread. The carcass has at least one carcass reinforcing ply and opposing bead portions. Each bead portion has a bead core and a bead apex radially. The apexes in each bead portion having the same radial height (HA), as measured from a bead base line (B). The tire has a bead reinforcing ply comprising carbon fiber reinforcing cords located in only one bead portion of the tire, with the bead reinforcing ply being adjacent to the carcass reinforcing ply.

U.S. Pat. No. 5,718,781 discloses a rubber tire composed of carbon black reinforced rubber carcass and having a rubber tread which is quantitatively reinforced with silica and contains a minor amount of carbon black reinforcement and/or carbon fibers. When said tread contains silica and carbon black reinforcement exclusive of carbon fibers, the said tread has a thin rubber layer over at least a portion of the outer surface tread intended to be ground-contacting wherein said rubber layer contains a combination of silica and/or carbon black reinforcement and carbon fibers. In one aspect, such alternative outer rubber layer (a) extends across at least a portion of the outer surface of the tread intended to be ground contacting and (b) contacts at least one other carbon black reinforced rubber component of the tire to provide a path of relatively low electrical resistance from said quantitatively silica reinforced tread to the bead portion of the tire carcass.

### II. SUMMARY OF THE INVENTION

Various carbon fibers, including short fibers and carbon cords, have been suggested for use in various rubber compositions, including tire treads. For example, see U.S. Pat. Nos. 5,323,829 and 5,718,781. A multi-filament carbon yarn has been suggested for reinforcement of rubber compositions in which the yarn is coated with a composite of resorcinol-formaldehyde reaction product, a vinylpyridine-styrene butadiene terpolymer, an acrylonitrile-butadiene copolymer and urea. For example, see U.S. Pat. Nos. 6,077,606 and 6,350,492.

For this invention, short, discontinuous carbon fibers are used for the rubber reinforcement which have been coated (pre-coated) with an adhesive composition (to aid, or enhance, adhesion of the carbon fibers to the elastomer) comprised of a vinylpyridine-styrene butadiene terpolymer, an acrylonitrile-butadiene copolymer and optionally urea (RFL adhesive coating).

In practice, such carbon fibers are preferably in a form of a cord comprised of twisted (cabled) carbon filaments having a carbon filament count (number of carbon filaments in the cord) preferably within a range of from about 1,000 to about 48,000. The average filament length (cord length) is preferably within a range of from about 1 mm (millimeter) to about 10 mm, optionally in a range of from about 3 mm to about 5 mm and an average diameter within a range of from about 2 to about 15 microns.

Representative of an adhesive coated carbon yarn is a carbon multi-filament yarn impregnated with a resorcinol-formaldehyde-rubber composite. The adhesive coated multi-filament yarn may then chopped into the short yarn fibers for use in this invention.

Such resorcinol-formaldehyde composite may be, for example, comprised of, and the product of, a resorcinol, formaldehyde, vinylpyridine/styrene/butadiene terpolymer latex and acrylonitrile/butadiene copolymer latex blend, which may optionally include urea. After application to and encapsulation of the carbon multi-filament yam, the blend is dried and cured at an elevated temperature in a sense of allowing the latices to dry and the resorcinol and formaldehyde to react and thereby form a resin within the resultant rubber and to thereby form the resorcinol-formaldehyde resin-rubber composite coated carbon filaments. The resorcinol and formaldehyde react with each other in situ within the latex binder to form an adhesive resin. The rubber copolymer(s), in one aspect, form a resultant binder for the resin. For an example of such coated carbon fibers, see U.S. Pat. No. 6,077,606. For convenience, the adhesive coating may be referred to herein as an RFL (resorcinol-formaldehyde-latex) adhesive coating. If desired, the carbon multi-filament yam may be pre-treated by impregnating the yam with an epoxy resin prior to its impregnation with the RFL composite in order to provide enhanced bonding of the filaments to the RFL composite.

The yam comprised of the RFL adhesive coated (encapsulated) carbon filaments is then chopped into short filamentary lengths and the coated filaments separated into short fibers, all by suitable means, for blending with and dispersing into the rubber composition.

A representative example of a multi-filament carbon yam for such RFL treatment, or coating, is, for example, T70GC™ from Toray Industries. In practice, the carbon yam may contain, for example, a range of from about 1,000 to about 48,000 carbon filaments.

In the description of this invention, the terms “rubber” and “elastomer” may be used interchangeably, unless otherwise provided. The terms “rubber composition”, “compounded rubber” and “rubber compound” may be used interchangeably to refer to “rubber which has been blended or mixed with various ingredients and materials” and such terms are well known to those having skill in the rubber mixing or rubber compounding art. The terms “cure” and “vulcanize” may be used interchangeably unless otherwise provided: In the description of this invention, the term “phr” refers to parts of a respective material per 100 parts by weight of rubber, or elastomer.

One advantage of this invention is that the addition of chopped carbon fibers can increase low strain stiffness and provide improved thermal conductivity.

Another advantage of this invention is that the addition of chopped carbon fibers to the apex will increase apex stiffness and provide improved handling.

Yet another possible advantage of this invention is the addition of chopped carbon fibers to the EMT insert can provide higher stiffness, which will provide more support during run flat conditions.

Yet another possible advantage of this invention is increased thermal conductivity can provide cooler running during normal operation as a result of increased heat dissipation and also a reduction of heat buildup during run flat conditions.

Another possible advantage of this invention is the addition of chopped carbon fibers in the overlay can provide support in the crown area of the tire and also help to dissipate heat from the area.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a cross-section of a tire, showing the apexes;

FIG. 2 is a cross-section of a EMT tire, showing the EMT insert; and,

FIG. 3 is a cross-section of the tire showing the belt overlays.

### IV. DEFINITIONS

The following terms may be used throughout the descriptions presented herein and should generally be given the following meaning unless contradicted or elaborated upon by other descriptions set forth herein.

“Apex” means an elastomeric filler located radially above the bead core and between the plies and the turn-up ends of the plies. The apex is sometimes referred to as a “bead filler”.

“Axial” and “axially” mean the lines or directions that are parallel to the axis of rotation of the tire.

“Carcass” means the tire structure apart from the belt structure, tread, undertread, and sidewall rubber over the plies, but including bead cores.

“Crown” or “tire crown” means the tread, tread shoulders, and the immediately adjacent portions of the sidewalls.

“dTex” means a unit of the linear density of a continuous filament or yarn, equal to 1/10th of a tex or 9/10th of a denier.

“EMT” means extended mobility technology tires.

“Interior” means, generally, the inside surface of the tire.

“Exterior” means, generally, the outside surface of the tire.

“Pneumatic tire” means a laminated mechanical device of generally toroidal shape (usually an open-torus) having bead cores and a tread and made of rubber, chemicals, fabric and steel or other materials. When mounted on the wheel of a motor vehicle, the tire through its tread provides traction and contains the fluid that sustains the vehicle load.

“Radial” and “radially” mean directions toward or away from the axis of rotation of the tire.

“Sidewall” means that component which comprises a portion of the outside surface of a tire between the tread and the bead.

“tow” means synthetic filaments prior to spinning.

“tow size” means the number of fiber filaments per tow size.

### V. DETAILED DESCRIPTION OF THE INVENTION

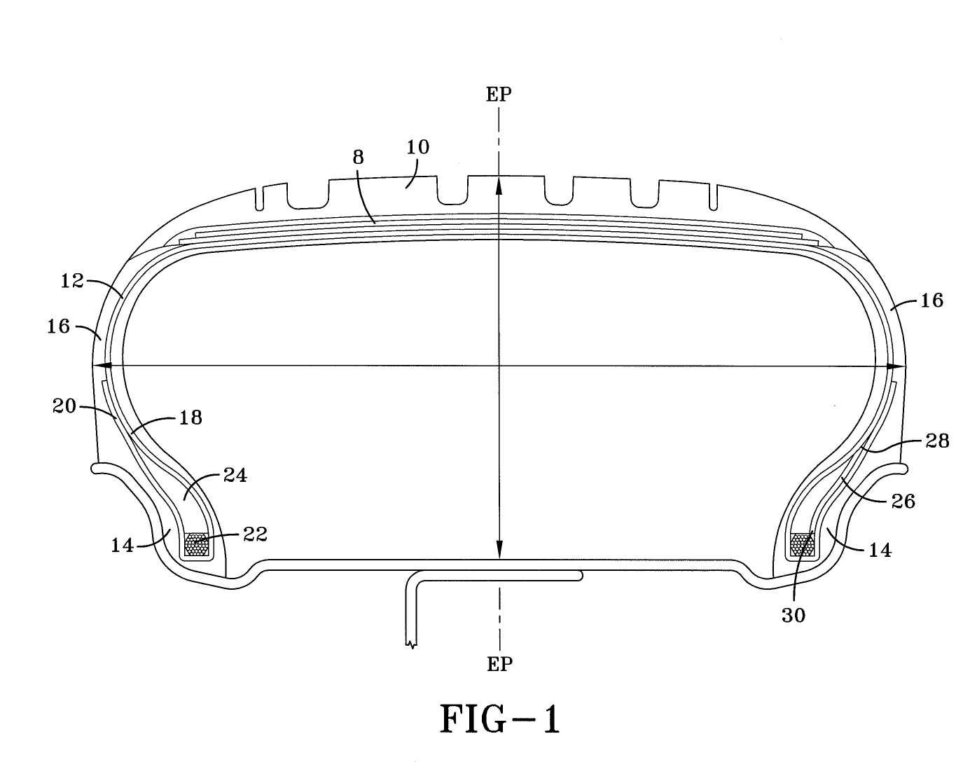

Referring now to the drawings wherein the showings are for purposes of illustrating embodiments of the invention only and not for purposes of limiting the same, FIG. 1 illustrates a pneumatic tire in accordance with the present invention. The pneumatic tire is a low aspect radial tire, designed for use as a high performance tire. The pneumatic tire has a carcass, a belt structure 8 radially outward of the carcass, and a tread 10 radially outward of the belt structure 8. The belt structure 8 may be any of the type conventionally used for a passenger vehicle tire, and generally will include two reinforcement plies of cords with overlay plies covering at least the axially outer edges of the individual belt reinforcement plies.

The carcass has at least one carcass reinforcing ply 12, a pair of opposing bead portions 14 and a pair of opposing sidewalls 16. The tire of FIG. 1 is illustrated as having one carcass reinforcing ply 12, but it is within the skill of those in the art to form the tire of FIG. 1 as a two ply carcass. The ply 12 has a main portion 18 extending through the opposing sidewalls 16 and two turnup portions 20 initiating in the bead portions 14. Each turnup portion 20 of the carcass reinforcing ply 12 extends from the main portion 18 of the carcass reinforcing ply 12, and is wrapped about a bead core 22 and a bead apex 24 in the bead portion 20; thus enveloping, at a minimum, the bead core 22 and the lower portion of the bead apex 24 in each bead portion 14.

The chopped carbon fibers in the apex 24 have a denier in the range of 667 dTex to 16,000 dTex, with one embodiment having a denier in the range of 4,000 to 8,000 dTex. The tow size range of the fibers is 1,000 to 24,000, with one embodiment having a range of 6,000 to 12,000. The fibers have a Young's modulus of 30,000-90,000 Kpsi, with one embodiment having a range of 30,000-40,000. The fibers may have a tensile strength in the range of 400,000 to 1000,000 psi, with one embodiment having a range of 600,000 to 740,000 psi. Additionally, the fibers have a maximum elongation in the range of 1.0 to 3.0%, and in one embodiment, a range of 1.6to 1.8%.

In one embodiment of the invention, as illustrated, the bead reinforcing ply 26 is located within the turnup envelope and directly adjacent to the bead apex 24. The bead reinforcing ply 26 extends from the initial point near the bead core 22 to a radially outer terminal end 28. The radially inner initial point 30 of the bead reinforcing ply 26 does not have any overlap with the bead core 22, but is spaced from the radially outer surface of the bead core 22 by a distance of at least 1.5 mm; preventing the end of the bead reinforcing ply 26 from being pinched between the bead core 22 and the carcass reinforcing ply 12.

The bead reinforcing ply 26 may be located in a variety of locations in the outboard side bead portion 14 in addition to the illustrated location of being axially outward of the carcass reinforcing ply turnup portion 20. The bead reinforcing ply 26 may be between the apex 24 and the carcass reinforcing ply turnup portion 20 (see FIG. 1), between the apex 24 and the carcass reinforcing ply main portion 18, or between the carcass reinforcing ply main portion 18 and a tire innerliner. In one embodiment, the two apexes could have different amounts of carbon fiber, and contemplates a situation wherein one apex 24 has no carbon fiber at all.

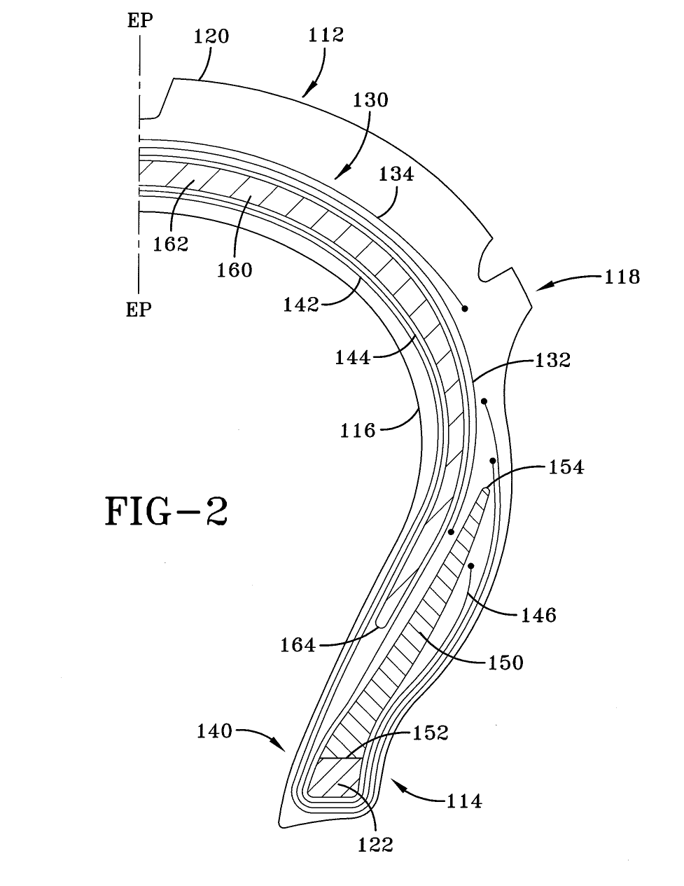

With reference now to FIG. 2, the term “runflat” is generally used to describe a tire that is designed such that the tire structure alone, and in particular the structure of the sidewalls, has sufficient strength and rigidity to support the vehicle load when the tire is operated without being inflated. The sidewalls and internal surfaces of such runflat tires or EMT tires do not collapse or buckle due to their rigidity, and the prevailing designs of such tires do not otherwise contain or use other supporting structures or devices to prevent the tire from collapsing. Examples of such other supporting structures are devices that might be contained within the tire and which experience no loading during normal inflated operation. In general, runflat tires or EMT tires incorporate sidewalls that are thicker and/or stiffer so that the tire's load can be carried by an uninflated tire with minimum adverse effects upon the tire itself and upon vehicle handling until such reasonable time as the tire can be repaired or replaced. The typical methods used in sidewall thickening and stiffening include the incorporation of circumferentially disposed EMT inserts 150 in the inner peripheral surface of the sidewall portion of the carcass, which is the region in the tire usually having the lowest resistance to deformation under vertical loading. In such runflat tire designs, each sidewall is thickened in the region between the bead and the tread shoulder. The EMT inserts 150 in each sidewall are generally crescent-shaped in cross-sectional view, in order to conform to the shape of the sidewalls. Such wedge reinforced sidewalls, when operated in the uninflated condition, experience a net compressive load in the region of the sidewall that is closest to the road-contacting portion of the tread. More specifically, the bending stresses on the sidewalls are such that the axially outwardmost portions of the reinforced sidewalls experience tensile stresses while the axially inward portions experience compressive stresses during runflat operation.

With continuing reference to FIG. 2, FIG. 2 is illustrative of a tire 100 having a tread region 112, two bead regions 114 (only one of which is shown) and two sidewalls 116 (only one of which is shown). Each sidewall extends between a respective one of the bead regions 114 and the tread region 112. The tread region 112 comprises a tread 120. The bead region 114 comprises a bead (or bead bundle) 122. A shoulder 118 of the tire is defined as the upper portion of sidewall 116 just below the lateral edge of the tread 120. A belt structure, or belt package 130, is disposed in the tread region 112, below the tread 120. A number of reinforcing plies 140 are disposed below the belt structure 130 and extend laterally beyond the lateral edges of the tread, radially in the sidewall to the bead(s) 122, wrap approximately 180 degrees around the beads, and extend radially back up into the sidewall 116. The belt package 130 comprises at least two belts—a first belt 132 and a second belt 134. The second belt 134 is disposed radially outward from the first belt 132. The belts 132, 134 both extend laterally across the tread region 112, and circumferentially around the tire, in a conventional manner. Each belt 132, 134 has lateral edges. In this embodiment, the tire 100 has at least three reinforcing, or carcass plies--a first ply 142, a second ply 144, and a third ply 146. The second ply 144 is radially outward from the first ply 142. The third ply 146 is radially outward from the second ply 144. The plies 142, 144,146 all extend from one bead 122, through the sidewall 116, across the tread region 112, through the other sidewall (not shown) to the other bead (not shown) of the tire, in a conventional manner. An EMT insert 150 is disposed atop the bead 122. The insert 150 is formed of high-modulus elastomer and extends into the sidewall 116 towards the tread region 112. In one embodiment, the EMT insert 150 could be coupled with an apex, wherein the apex would be stiffer than the insert 150, and the insert 150 could overlay the apex.

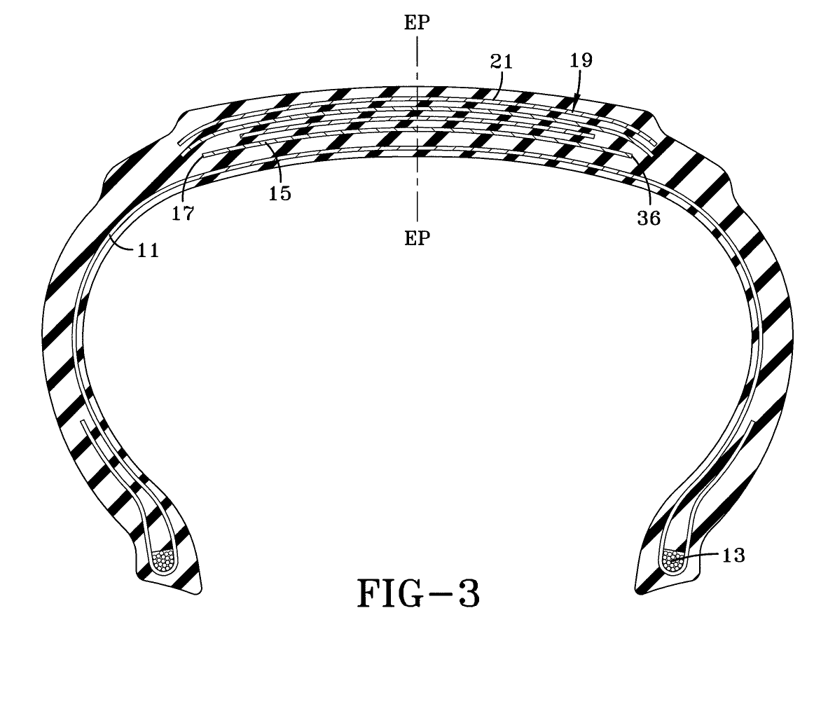

With reference now to FIG. 3, an overlay structure 19 is disposed radially outwardly of the belt reinforcing structure 14 and is wrapped circumferentially thereabout. A tread 22 of an elastomeric compound is disposed radially outwardly of the overlay structure 19. Preferably, the overlay structure 19 extends axially outwardly of the lateral edges 17, 32 of the widest belt ply 15. In the embodiment illustrated in FIG. 3, the overlay structure comprises a sheet of an elastomer having side by side nylon cables embedded therein with the sheet having an axial width which is greater than the distance between the lateral edges 17, 32 of the widest belt ply 15 of the belt reinforcing structure. The overlay ply is usually applied to the unvulcanized tire as an annular layer, or layers, with the two end portions of the ply slightly overlapping to form a splice.

In accordance with the invention, the short carbon fibers have an average length within a range of from about 1 to about 10 millimeters, alternately within a range of from about 3 to about 5 millimeters, and an average diameter within a range of from about 2 to about 15 microns;

In accordance with the invention, the carbon fibers have a coating thereon comprised of wherein the carbon fibers have an RFL adhesive coating thereon comprised of a resorcinol-formaldehyde resin and polymeric binder.

As hereinbefore discussed, such RFL adhesive, as is well known to those having skill in such art, and as further discussed in the aforesaid U.S. Pat. No. 6,077,606, may be, for example a resorcinol-formaldehyde composite as a resinous product of resorcinol and formaldehyde together with a vinylpyridine/styrene/butadiene terpolymer (from a latex thereof) and acrylonitrile/butadiene copolymer (from a latex thereof) blend, which may optionally include urea. As also hereinbefore discussed, the carbon fibers may optionally be impregnated with an epoxy prior to coating with the RFL adhesive composite.

In further addition to the invention, the rubber composition of at least one of the apexes, EMT inserts, and/or belt overlays, which contain the adhesive (RFL) coated carbon fibers may contain an in situ formed resin as the product of a methylene donor and methylene acceptor (e.g. resorcinol and hexamethoxymethyl melamine).

In practice, the RFL coated carbon fibers and methylene donor are mixed with the rubber composition prior to mixing the methylene acceptor upon which the methylene donor/methylene acceptor resin is formed in situ within the rubber composition in the presence of the RFL adhesive coated carbon fiber dispersion.

Representative of various methylene donor compounds are, for example, methylene donor compounds comprised of at least one of hexamethoxymethylmelamine, hexamethylenetetramine, methoxymethyl melamine, N,N′N″-trimethyl N,N′N″-trimethylolmelamine, hexamethylomelamine, N,N′N″-dimethylolmelamine, N-methylolmelamine, N,N′-dimethylolmelamine, N,N′N″-tris(methoxymethyl)melamine, N,N′N″-tributyl-N,N′N″-trimethyloi-melamine and hexaethoxymethylmelamine.

The amount of the methylene donor compound in the rubber composition may vary. For example, it may be contained, as a component of the resinous reaction product of methylene donor and methylene acceptor, in the rubber composition in an amount in a range of from about 0.5 to about 4 phr.

Representative of various methylene acceptor compounds are, for example, methylene acceptor compounds comprised of at least one of resorcinol, resorcinolic derivatives, monohydric phenols and derivatives thereof, dihydric phenols and derivatives thereof, polyhydric phenols and derivatives thereof, unmodified phenol novolak resins, modified phenol novolak resin, and novolak resins.

The term “methylene acceptor” is known to those having skill in such art and is used to describe the reactant or compound with which the methylene donor compound reacts to form what is believed to be an intermediate methylol monomer. It is envisioned that a condensation of the intermediate methylol monomer by formation of a methylene bridge produces a resin material. The initial reactant for which it is envisioned contributes the moiety that later forms the methylene bridge and ultimately the resin is referred to as being the methylene donor compound and the other reactant is referred to as being the methylene acceptor compound. Examples of methylene acceptors are indicated above and include, for example, but are not limited to those disclosed in U.S. Pat. Nos. 6,605,670, 6,472,457, 5,945,500, 5,936,056, 5,688,871, 5,665,799, 5,504,127, 5,405,897, 5,244,725, 5,206,389, 5,194,513, 5,030,692, 4,889,481, 4,605,696, 4,436,853 and 4,092,455. Examples of modified novolak resins include, for example, but are not limited to, cashew nut oil (e.g. cashew nut shell oil) modified phenol novolak resin, tall oil modified phenol novolak resin and alkyl modified phenol novolak resin such as, for example, SP6700™. In one embodiment, the methylene acceptor compound is resorcinol.

The amount of methylene acceptor compound in the rubber composition may vary, depending somewhat upon selection and amount of methylene donor compound used as well as the selection of the methylene acceptor compound itself and a desired ratio of methylene donor compound to methylene acceptor compound. For example, the amount of methylene acceptor compound, as a component of the resinous reaction product of the methylene donor and methylene acceptor, may be in a range of from about 0.5 to about 5, alternatively from about 1 to about 3 phr.

A weight ratio of the methylene acceptor compound to methylene donor compound may range, for example, from about 5/1 to about 1/5.

In practice, the adhesive coating on the carbon fibers is the aforesaid resorcinol-formaldehyde resin composite of resorcinol-formaldehyde resin, which may also optionally contain urea, in the copolymer rubber binder.

In practice, the short carbon fibers may be significantly aligned (e.g. from about 20 to about 80 percent, or more, aligned which is considered herein to be significantly aligned on a relative basis, namely as compared to being randomly dispersed and not aligned altogether) with each other in the direction of the flow of the rubber composition by a contraction extrusion of the rubber composition (extrusion of the uncured rubber composition) through a suitable shaping die. By contraction extrusion, it is meant that the volumetric flow of the rubber composition extruded through a shaping die is contracted (e.g. by a reduction of the cross-section of the conduit through which the rubber composition flows) as the rubber composition approaches the die opening and is expanded (e.g. an en expansion of the cross-section of the conduit through which the rubber composition flows) as it leaves the shaping die opening. In such manner, then, a rubber tire tread may be formed which contains short carbon fibers which are substantially aligned with each other in parallel manner in the longitudinal, circumferential, direction of the tread (as it appears on the tire). Such alignment of the short carbon fibers may be beneficial in a sense of being able to maximize directional stiffness of the extruded rubber composition.

Alternatively, the short carbon fibers may be significantly aligned (e.g. from about 10 to about 40 percent, or more, aligned which is considered herein to be significantly aligned on a relative basis, namely as compared to being randomly dispersed and not aligned altogether) with each other in the direction substantially perpendicular (e.g. from about 10 to about 30 percent of from the perpendicular in a sense of being perpendicular) to the flow of the rubber composition by an expansion extrusion of the rubber composition (extrusion of the uncured rubber composition) through a suitable shaping die. By expansion extrusion, it is meant that the volumetric flow of the rubber composition extruded through a shaping die is expanded (e.g. the cross-section of the conduit through the rubber composition flows is enlarged through which the rubber composition flows) as the rubber composition approaches the die opening and is contracted (e.g. by a reduction of the cross-section of the conduit through which the rubber composition flows) as the rubber composition leaves the die opening.

### Example 1

### Apex Compounds

TABLE 1

| | Sample A (phr) | Sample B (phr) |
|---|---|---|
| Non-productive Mix | | |
| Natural Rubber^{a} | 100 | 100 |
| Carbon Black^{b} | 80 | 80 |
| Processing Oil^{c} | 7 | 7 |
| Zinc Oxide | 5 | 5 |
| Stearic Acid | 2 | 2 |
| Tackifier^{d} | 2 | 2 |
| Chopped carbon fiber^{e} | 0 | 5 |
| Productive Mix | | |
| Methylene donor^{f} | 3 | 3 |
| Methylene acceptor^{g} | 10 | 10 |
| Accelerator + retarder^{h} | 3.3 | 3.3 |
| Sulfur | 4.4 | 4.4 |

^{a}TSR20
^{b}N326 type
^{c}naphthenic/paraffinic type
^{d}SP1068 from Schenectady
^{e}resorcinol-formaldehyde adhesive coated short carbon fibers, 5 mm length, 7 micron diameter.
^{f}hexamethylene tetramine
^{g}phenol formaldehyde reactive type resin
^{h}sulfenamide accelerator and phthalimide retarder

TABLE 2

| | Sample A | Sample B |
|---|---|---|
| Carbon fiber | 0 | 5 |
| Rheometer, 150° C. | | |
| Maximum torque, dNm | 91.3 | 95.4 |
| Minimum torque, dNm | 3.4 | 3.7 |
| Delta torque, dNm | 87.9 | 91.7 |
| T₉₀, minutes | 15.4 | 15.1 |
| RPA (100° C., 11 Hz)^{a} | | |
| G¹ @ 1% strain (MPa) | 23.3 | 25.9 |
| G¹ @ 5% strain (MPa) | 16.2 | 17.9 |
| TanDelta @ 1% strain | 0.078 | 0.073 |
| TanDelta @ 5% strain | 0.112 | 0.116 |

^{a}Rubber Process Analyzer as RPA 2000 ™ instrument from Alpha Technologies.

### Example 2

### Ply coat/Overlay Compounds

TABLE 3

| | Sample C (phr) | Sample D (phr) |
|---|---|---|
| Non-productive Mix | | |
| Natural Rubber^{a} | 100 | 100 |
| Carbon Black^{b} | 41 | 41 |
| Processing Oil^{c} | 9 | 9 |
| Zinc Oxide | 3 | 3 |
| Tackifier^{d} | 1 | 1 |
| Methylene acceptor^{e} | 1 | 1 |
| Chopped carbon fiber^{f} | 0 | 5 |
| Productive Mix | | |
| Sulfenamide accelerator | 1.4 | 1.4 |
| Methylene donor^{g} | 1.8 | 1.8 |
| Sulfur | 2.4 | 2.4 |

^{a}TSR20
^{b}N326 type
^{c}naphthenic/paraffinic type
^{d}SP1068 from Schenectady
^{e}Pennacolite B-195
^{f}hexamethylene tetramine
^{g}hexamethoxymethylmelamine

TABLE 4

| | Sample C | Sample D |
|---|---|---|
| Carbon fiber | 0 | 5 |
| Rheometer, 150° C. | | |
| Maximum torque, dNm | 17.0 | 17.3 |
| Minimum torque, dNm | 2.8 | 2.7 |
| Delta torque, dNm | 14.2 | 14.6 |
| T₉₀, minutes | 4.4 | 4.6 |
| RPA (100° C., 11 Hz)^{a} | | |
| G¹ @ 1% strain (MPa) | 1.4 | 1.5 |
| G¹ @ 50% strain (MPa) | 0.64 | 0.65 |
| TanDelta @ 10% strain | 0.13 | 0.13 |
| Adhesion to Nylon cord, N | 83 | 126 |
| @ 23° C. | | |

TABLE 4A

| | Sample C | Sample D | Sample C | Sample D |
|---|---|---|---|---|
| Stress-Strain | With Grain | Against | With | Against |
| | | Grain | Grain | Grain |
| Tensile Strength | 16.0 | 16.3 | 14.4 | 13.1 |
| Elong at break, % | 506 | 517 | 436 | 448 |
| 100% modulus (MPa) | 1.45 | 1.31 | 3.05 | 2.09 |
| 300% modulus (MPa) | 7.05 | 6.55 | 8.79 | 7.43 |

### Example 3

TABLE 5

| | Sam- | Sam- | Sam- | Sam- | Sam- |
|---|---|---|---|---|---|
| | ple E | ple F | ple G | ple H | ple I |
| Carbon fiber | 0 | 5 | 10 | 15 | 20 |
| Rheometer, 150° C. | | | | | |
| Max T | 19.3 | 19.6 | 20.3 | 20.5 | 21.4 |
| Min T | 3.1 | 2.8 | 2.8 | 2.8 | 3.1 |
| Delta T | 16.2 | 16.8 | 17.1 | 17.7 | 18.3 |
| T₉₀ | 4.6 | 5.0 | 5.0 | 5.0 | 4.8 |
| RPA (100° C., 11 Hz) | | | | | |
| G¹ @ 1% strain (MPa) | 1.27 | 1.33 | 1.46 | 1.49 | 1.63 |
| G¹ @50% strain (MPa) | 0.64 | 0.64 | 0.68 | 0.71 | 0.74 |
| TanDelta @ 10% strain | 0.13 | 0.14 | 0.14 | 0.14 | 0.13 |
| Stress Strain | | | | | |
| Tensile strength, WG | 16.1 | 14.0 | 12.7 | 12.2 | 12.0 |
| Tensile strength, AG | 15.5 | 13.8 | 13.1 | 12.8 | 12.4 |
| Elong % at break, WG | 518 | 436 | 367 | 335 | 311 |
| Elong % at break, AG | 552 | 510 | 494 | 456 | 438 |
| 100% modulus, WG | 1.4 | 3.2 | 4.7 | 5.5 | 6.2 |
| 100% modulus, AG | 1.2 | 1.5 | 1.7 | 2.1 | 2.5 |
| 300% modulus, WG | 6.8 | 8.6 | 10.2 | 10.8 | 11.7 |
| 300% modulus, AG | 5.4 | 6.0 | 6.3 | 7.5 | 8.0 |
| Adhesion to nylon cord | 83 | 113 | 122 | 115 | 133 |
| @ 23° C. | | | | | |

The present invention provides the desired stiffness, while creating little change in hysteresis (heat build-up). Increased stiffness in the apex improves handling. Increased stiffness in the EMT insert provides runflat mobility and the necessary stiffness for runflat operation. Increased stiffness in the belt overlay provides overall stability to the crown area and improves handling, uniform wear, and durability. Typically, increased stiffness requires increased hysteresis, and is obtained with fillers and/or resins.

With reference to the above Examples and Tables, the data show an increased stiffness with little change in the hysteresis (heat build-up). With respect to the EMT insert, the increased stiffness helps provide support without heat build-up during normal running conditions, which is needed during run flat operation. With respect to Table 4A, the data shows an advantage of additional stiffness with the grain.

Various embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1. A tire comprising:
a carcass;
at least two bead regions having a pair of axially spaced beads around which are wrapped turn-up ends;
reinforced carcass plies wrapped around the pair of beads;
at least one belt structure and tread disposed over the carcass plies;
sidewalls disposed between the beads and the tread;
at least two apexes, wherein the apexes are a main body of the carcass and the turn-up ends;
at least one belt overlay; wherein at least one of the group consisting of at least one of the apexes and the at least one belt overlay contain chopped carbon fibers.

2. The tire of claim 1, wherein the chopped carbon fibers are resorcinol-formaldehyde-latex (RFL) treated carbon fibers having a twist per inch of 1.2 to 1.6.

3. The tire of claim 1, wherein the adhesive (RFL) coated carbon fibers contain an in situ formed resin, wherein the resin is a methylene donor and a methylene acceptor.

4. The tire of claim 3, wherein the methylene donor is chosen from at least one of the group comprising: hexamethoxymethylmelamine, hexamethylenetetramine, methoxymethyl melamine, N,N′N″-trimethyl N,N′N″-trimethylolmelamine, hexamethylomelamine, N,N′N″-dimethylolmelamine, N-methylolmelamine, N,N′-dimethylolmelamine, N,N′N″-tris(methoxymethyl)melamine, N,N′N″-tributyl-N,N′N″-trimethyloi-melamine and hexaethoxymethylmelamine and the methylene acceptor is chosen from at least one of the group comprising: resorcinol, resorcinolic derivatives, monohydric phenols and derivatives thereof, dihydric phenols and derivatives thereof, polyhydric phenols and derivatives thereof, unmodified phenol novolak resins, modified phenol novolak resin, and novolak resins.

5. The tire of claim 2, wherein the chopped carbon fibers are carbon fibers which have a coating thereon which is comprised of an RFL adhesive coating comprised of a resorcinol-formaldehyde resin and polymeric binder.

6. The tire of claim 5, wherein the RFL adhesive is a resorcinol-formaldehyde resinous product of resorcinol and formaldehyde together with a vinylpyridine/styrene/butadiene terpolymer and acrylonitrinle/butadiene copolymer, which optionally contains urea.

7. The tire of claim 6, wherein the carbon fibers are impregnated with an epoxy prior to coating with the RFL adhesive composite.

8. The tire of claim 1, wherein the carbon fibers are randomly dispersed.

9. The tire of claim 1, wherein the carbon fibers are substantially aligned parallel to each other.

10. The tire of claim 1, wherein the carbon fibers have an average length within a range of from about 1 to about 10 millimeters and an average diameter within a range of from about 2 to about 15 microns.

11. The tire of claim 1, wherein the carbon fibers have a denier in the range of 667 dTex to 16,000 dTex.

12. The tire of claim 11, wherein the carbon fibers are inclined at an angle in the range of 30° to 60° relative to the circumferential direction of the tire.

13. The tire of claim 1, wherein the carbon fibers have a tow size range of 1,000 to 24,000.

14. The tire of claim 13, wherein the carbon fibers have a tow size range of 6,000 to 12,000 and have an ends per inch in the range of 10 to 30.

15. The tire of claim 1, wherein the carbon fibers are present in the amount of 0.5 to 30 phr

16. The tire of claim 15, wherein the carbon fibers are present in the amount of 1 to 20 phr.

17. The tire of claim 1, wherein the carbon fibers are each completely encapsulated in adhesive and there is no fiber clumping.

18. A tire comprising:
a carcass;
at least two bead regions having a pair of axially spaced beads around which are wrapped turn-up ends;
reinforced carcass plies wrapped around the pair of beads;
at least one belt structure and tread disposed over the carcass plies;
sidewalls disposed between the beads and the tread;
at least two apexes, wherein the apexes are a main body of the carcass and the turn-up ends;
an EMT insert; and,
at least one belt overlay; wherein at least one of the group consisting of at least one of the apexes, the EMT insert, and the at least one belt overlay contain chopped carbon fibers.

19. The tire of claim 18, wherein the carbon fibers
have an average length within a range of from about 1 to about 10 millimeters;
have an average diameter within a range of from about 2 to about 15 microns;
have a denier in the range of 667 dTex to 16,000 dTex;
have a tow size range of 1,000 to 24,000; and,
are present in the amount of 0.5 to 30 phr.

20. The tire of claim 19, wherein the chopped carbon fibers are resorcinol-formaldehyde-latex (RFL) treated carbon fibers having a twist per inch of 1.2 to 1.6.
